(19) United States
(12) Patent Application Publication
(10) Pub. No.: US 2026/0286053 A1
(43) Pub. Date: Sep. 24, 2026

(54) Compound Of Q-CTF-OH Having Covalent Triazine Framework, Method Of Making The Same, Method Of Preparing Cathode Of Metal Ion Battery, And Metal Ion Battery

(71) Applicant: National Cheng Kung University, Tainan City (TW)

(72) Inventors: Teng-hao CHEN, Tainan City (TW); Watchareeya KAVEEVIVITCHAI, Tainan City (TW); Thi Huynh Nhu LUU, Tainan City (TW)

(21) Appl. No.: 19/293,694

(22) Filed: Aug. 7, 2025

(30) Foreign Application Priority Data
Mar. 18, 2025 (TW) 114110145

(51) Int. Cl. C08G 73/06; H01M 10/0568; H01M 10/0569

(52) U.S. Cl. CPC C08G 73/065; H01M 10/0568; H01M 10/0569; H01M 2300/0037

(57) ABSTRACT

A method of preparing a compound of Q-CTF-OH having a covalent triazine framework is disclosed by the present disclosure. The method comprises steps of reacting 1,4-dicyano-2,3,5,6-tetrahydroxybenzene monomer with ZnCl₂ in a vacuum to obtain a solid, wherein a molar ratio of the 1,4-dicyano-2,3,5,6-tetrahydroxybenzene monomer to the ZnCl₂ ranges from 1:0.5 to 1:10, and the reaction is conducted by heating the 1,4-dicyano-2,3,5,6-tetrahydroxybenzene monomer with the ZnCl₂ from room temperature to a temperature in a range of 300 to 500° C., and maintaining the temperature within the range for 10 to 48 hours. A compound of Q-CTF-OH having a covalent triazine framework, a method of preparing a cathode of a metal ion battery, and a metal ion battery are further disclosed by the present disclosure.

### CROSS-REFERENCE TO RELATED APPLICATIONS

This application claims the benefit of Taiwan Patent Application No 114110145, filed on Mar. 18, 2025, which is hereby incorporated by reference in its entirety herein.

### FIELD OF INVENTION

The present disclosure relates to a cathode material of a battery, and in particular to a compound Q-CTF-OH having a covalent triazine framework, a method of making the same, a method of preparing a cathode of a metal ion battery, and a metal ion battery.

### BACKGROUND OF INVENTION

Sustainable organic electrode materials have gained tremendous attention recently as a major alternative to the non-renewable inorganic intercalation electrodes. Covalently assembled organic frameworks are characterized by structural design flexibility, redox tunability, high stability, and low-carbon-footprint processing.

Covalent triazine frameworks (CTFs) with porous non-crystalline features are promising due to easily accessible redox-active sites and bipolar triazine centers capable of undergoing both n-doping and p-doping redox processes, thus leading to extra-high-performance energy storage. Benzoquinones exhibit high redox potentials and enable two-electron transfer reactions, offering suitability for use as cathode materials. However, since CTF synthesis requires a pair of cyano groups on one monomer, there are very few monomer candidates available for incorporating benzoquinone units into cathode materials with covalent triazine frameworks. In addition, to incorporate both benzoquinone and cyano groups within a single structure, a monomer typically needs to be elongated, resulting in excessive electrochemically inactive segments that ultimately limit energy storage performance.

Accordingly, there is a need to improve cathode materials having covalent triazine frameworks.

### SUMMARY OF INVENTION

### Technical Problems

In order to increase redox-active site density of an obtained compound, a main purpose of the present disclosure is to provide a method of preparing a compound of Q-CTF-OH having a covalent triazine framework (CTF), thereby improving electrochemical energy storage performance of the compound when used as a cathode material in batteries.

### Technical Solutions

In order to achieve the foregoing purpose of the present disclosure, the present disclosure provides a method of preparing a compound of Q-CTF-OH having a covalent triazine framework as represented in the following formula (I):

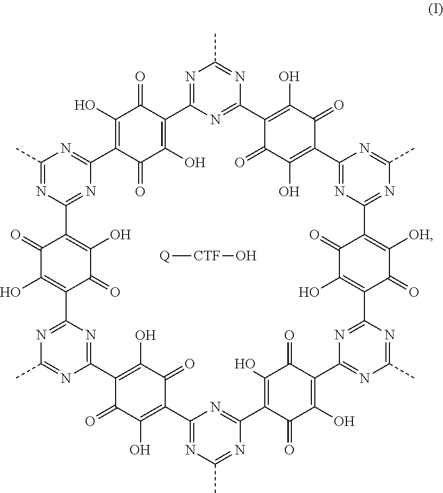

wherein the method comprises steps of: S10: reacting 1,4-dicyano-2,3,5,6-tetrahydroxybenzene monomer with ZnCl₂ in a vacuum to obtain a solid, wherein a molar ratio of the 1,4-dicyano-2,3,5,6-tetrahydroxybenzene monomer to the ZnCl₂ ranges from 1:0.5 to 1:10, the 1,4-dicyano-2,3,5,6-tetrahydroxybenzene monomer and the ZnCl₂ are heated from room temperature to a temperature in a range of 300 to 500° C., and the temperature is maintained for 10 to 48 hours, so as to obtain the solid.

In one embodiment of the present disclosure, the method further comprises steps of: S20: cooling the solid to room temperature; S30: grinding the solid to obtain a crude product; S40: washing the crude product with water for a first time; S50: stirring the crude product in an acid solution after first washing; S60: washing the crude product with water and tetrahydrofuran for a second time; and S70: drying the crude product after second washing to obtain the compound of Q-CTF-OH.

In one embodiment of the present disclosure, in step S10, a heating rate ranges from 1 to 5° C./min.

In one embodiment of the present disclosure, in step S40, the crude product is washed for the first time with water under sonication.

In one embodiment of the present disclosure, in step S50, time of stirring ranges from 10 to 48 hours.

In one embodiment of the present disclosure, in step S70, a temperature of drying ranges from 50 to 180° C.

In one embodiment of the present disclosure, in step S70, time of drying ranges from 10 to 48 hours.

In order to achieve the foregoing purpose of the present disclosure, the present disclosure further provides a compound of Q-CTF-OH as represented in the following formula (I) prepared by the method as described above,

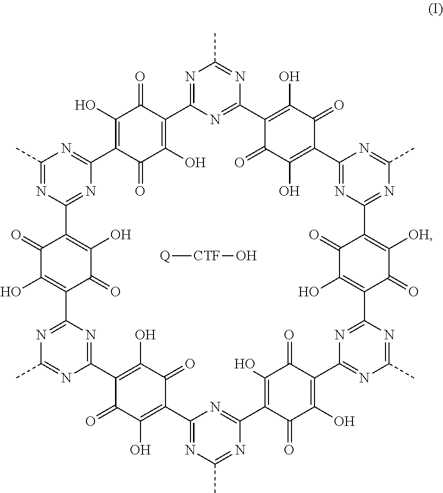

wherein the compound comprises a covalent triazine framework.

In order to achieve the foregoing purpose of the present disclosure, the present disclosure further provides a method of preparing cathode of metal ion battery as described above, comprising steps of: S01: grinding the compound of Q-CTF-OH prepared by the method as mentioned above, a conductive carbon additive, and a fluorine-containing polymer together to obtain a mixture, wherein a weight ratio of the compound of Q-CTF-OH, the conductive carbon additive, the fluorine-containing polymer ranges from 3:6:1 to 8:1:1, and the fluorine-containing polymer comprises polyvinylidene fluoride or polytetrafluoroethylene; S02: adding water, ethanol, or N-methyl-2-pyrrolidinone to the mixture to form a slurry; and S03: coating a current collecting layer with the slurry and drying the current collecting layer in a vacuum at 90 to 110° C., so as to obtain the cathode of the metal ion battery.

In one embodiment of the present disclosure, the current collector layer is a conductive carbon substrate.

In order to achieve the foregoing purpose of the present disclosure, the present disclosure further provides a metal ion battery, comprising: a cathode, a separator, an anode, and an electrolyte, wherein the cathode is the cathode as described above, the anode is separated from the cathode by the separator, the anode is a metal or alloy thereof, and the electrolyte is added between the cathode and the anode, wherein the electrolyte is ethylene carbonate/diethyl carbonate electrolyte solution containing lithium hexafluorophosphate.

In one embodiment of the present disclosure, a concentration of the lithium hexafluorophosphate in the electrolyte of the ethylene carbonate/diethyl carbonate electrolyte solution ranges from 0.5 to 2 M.

In one embodiment of the present disclosure, the metal is selected from the group consisting of lithium, sodium, potassium, magnesium, and zinc.

### Beneficial Effects:

Q-CTF-OH having a covalent triazine framework obtained by the method of preparing the compound of Q-CTF-OH having a covalent triazine framework of the present disclosure has a benzoquinone-based framework in which all hydrogen atoms are substituted with hydroxyl groups, and polar hydroxyl groups enable stable accommodation of lithium ions within porous structure, which is conducive to exceptionally high electrochemical performance. When applied in lithium-ion batteries, Q-CTF-OH delivers a high discharge capacity of up to 689 mAh g⁻¹ at a current density of 200 mA g⁻¹. Even under a high charge/discharge rate of 20 A g⁻¹, the lithium-ion batteries retain a capacity of 118 mAh g⁻¹ after 2000 cycles, with a capacity retention of 97%. The electrochemical performance of Q-CTF-OH of the present disclosure surpasses that of conventional organic porous cathode materials. In addition, porosity and redox activity of the organic functional groups present in Q-CTF-OH of the present disclosure can be applied to various metal ion batteries, such as sodium-ion batteries, potassium-ion batteries, magnesium-ion batteries, and zinc-ion batteries, with broader applicability and greater sustainability compared to conventional inorganic electrodes.

### DESCRIPTION OF DRAWINGS

In order to more clearly illustrate the above contents of the present disclosure, the following is a detailed description of the preferred embodiments with reference to the accompanying drawings:

FIG. 1 is a flow chart of a method of preparing a compound of Q-CTF-OH having a covalent triazine framework according to an embodiment of the present disclosure.

FIG. 2. illustrates idealized structure of Q-CTF-OH synthesized from ionothermal trimerization of aromatic nitrile LH₄ monomer.

FIG. 3 is a flow chart of a method of preparing cathode of metal ion battery according to an embodiment of the present disclosure.

FIG. 4a illustrates Fourier-transform infrared (FT-IR) spectra of LH₄ and Q-CTF-OH; FIG. 4b illustrates solid-state ¹³C NMR spectra of Q-CTF-OH and model compounds 1 and 2; FIG. 4c illustrates O 1s XPS spectrum of Q-CTF-OH; FIG. 4d illustrates 77K N₂ adsorption/desorption isotherms and pore size distribution of Q-CTF-OH; FIG. 4e illustrates Raman spectrum of Q-CTF-OH; and FIG. 4f illustrates high-resolution transmission electron microscopy (HR-TEM) image and measured spacing of layered structure of Q-CTF-OH.

FIG. 5a illustrates galvanostatic discharge/charge profiles of Q-CTF-OH at a current density of 200 mA g⁻¹ (Q-CTF-OH:Ketjenblack:PVDF=3:6:1); FIG. 5b, FIG. 5c, and FIG. 5d illustrate voltage profiles at 100 mA g⁻¹ (FIG. 5b), rate capability plot (FIG. 5c), and long-term cycling performance of Q-CTF-OH at 10 and 20 A g⁻¹ for 2000 cycles (FIG. 5d), respectively (Q-CTF-OH:Ketjenblack:PVDF=6:3:1); and FIG. 5e illustrates cyclic voltammogram of Q-CTF-OH at 0.5 mV s⁻¹.

FIG. 6a and FIG. 6b illustrate electrochemical results of lithium-ion batteries made of Q-CTF-OH synthesized at different temperatures (Q-CTF-OH:Ketjen black:PVDF=6:3:1).

FIG. 7 illustrates capacity retention of the lithium-ion batteries (Q-CTF-OH:Ketjen black:PVDF=3:6:1) at current densities of 200, 500, and 1000 mA g⁻¹.

FIG. 8 illustrates capacity retention of lithium-ion batteries (Q-CTF-OH:Ketjen black:PVDF=3:6:1) at current densities of 3, 5, 10, and 20 A g⁻¹.

FIG. 9 illustrates capacity retention of the lithium-ion batteries (Q-CTF-OH:Ketjen black:PVDF=6:3:1) at current densities of 100, 200, and 500 mA g⁻¹.

FIG. 10 illustrates capacity retention of lithium-ion batteries with different contents of Q-CTF-OH at a current density of 500 mA g⁻¹ with PVDF constantly maintained at 10 wt %.

FIG. 11a and FIG. 11b illustrate a comparison of electrochemical performance between a full cell (graphite/Q-CTF-OH) and a half cell (Li/Q-CTF-OH) at a current density of 500 mA g⁻¹ within a voltage range of 1.0 to 4.3 V, wherein for the full cell, a graphite anode (graphite:Ketjen black:PVDF=8:1:1) was prelithiated at 100 mA g⁻¹ over a voltage window of 0 to 3.0 V, and the cathode of Q-CTF-OH was prepared with a weight ratio of Q-CTF-OH:Ketjenblack:PVDF=6:3:1.

FIG. 12 illustrates X-ray photoelectron spectroscopy (XPS) spectra of Q-CTF-OH synthesized at different temperatures.

### DETAILED DESCRIPTION OF PREFERRED EMBODIMENTS

In order to describe the technical solutions of the present disclosure more clearly, numerous specific details are provided in the following specific embodiments. Apparently, the present disclosure can be practiced without certain specific details.

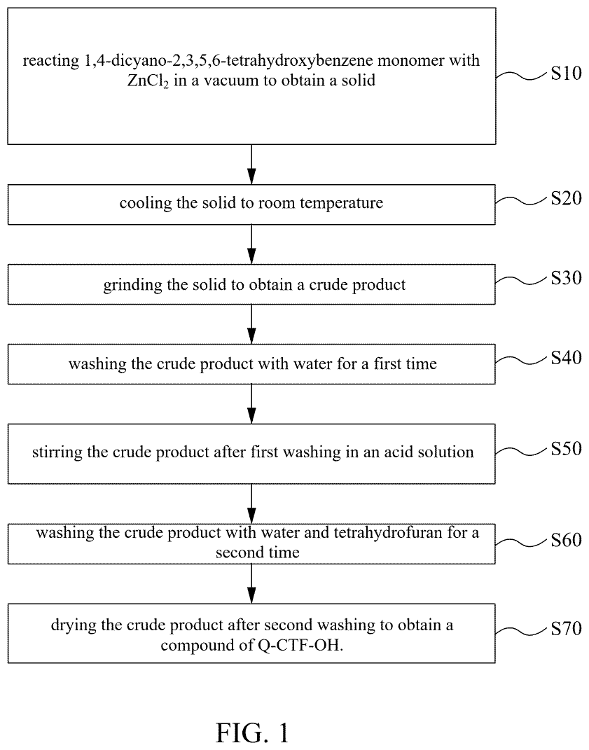

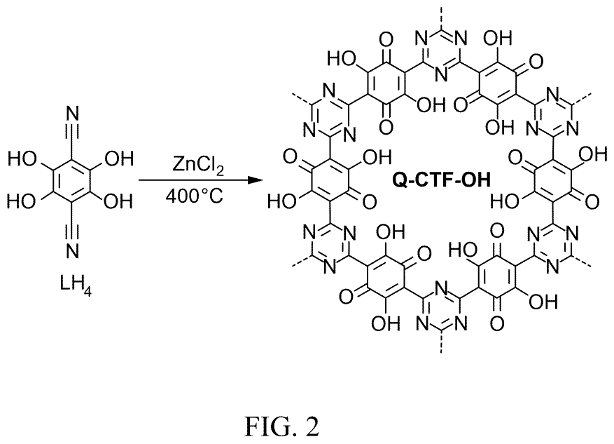

Refer to FIG. 1 and FIG. 2. A method of preparing a compound of Q-CTF-OH having a covalent triazine framework (CTF) according to an embodiment of the present disclosure, in which the compound of Q-CTF-OH is represented in the following formula (I),

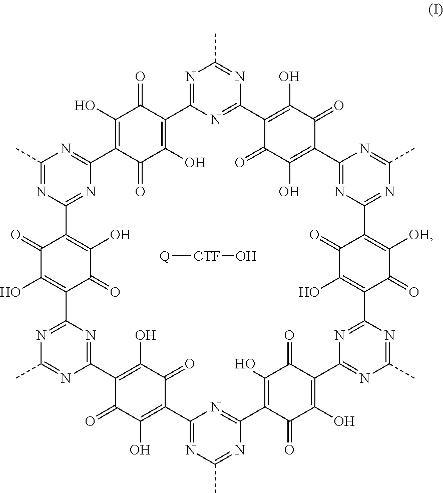

comprises the following steps.

Step S10: 1,4-dicyano-2,3,5,6-tetrahydroxybenzene monomer is reacted with ZnCl₂ in a vacuum to obtain a solid, wherein a molar ratio of the 1,4-dicyano-2,3,5,6-tetrahydroxybenzene monomer to the ZnCl₂ ranges from 1:0.5 to 1:10 (e.g., 1:0.5, 1:0.6, 1:0.7, 1:0.8, 1:0.9, 1:1, 1:2, 1:3, 1:4, 1:5, 1:6, 1:7, 1:8, 1:9, or 1:10). The 1,4-dicyano-2,3,5,6-tetrahydroxybenzene monomer and the ZnCl₂ are heated from room temperature to a temperature in a range of 300 to 500° C. (e.g., 300, 350, 400, 450, or 500° C.), and the temperature is maintained for 10 to 48 hours (e.g., 10, 12, 14, 16, 18, 20, 22, 24, 26, 28, 30, 32, 34, 36, 38, 40, 42, 44, 46, or 48 hours). Specifically, in the step, a heating rate ranges from 1 to 5° C./min, for example, 1, 2, 3, 4, or 5° C./min.

Step S20: The solid is cooled to room temperature.

Step S30: The solid is ground to obtain a crude product. For example, the solid may be ground in a mortar to obtain a crude product. Preferably, the solid is ground thoroughly to yield a uniform powder.

Step S40: The crude product is first washed with water. Preferably, the crude product is washed with water under sonication to enhance cleaning quality.

Step S50: The crude product after first washing is stirred in an acid solution, for example, in a 0.8 to 1.5 M (e.g., 0.8, 0.9, 1, 1.1, 1.2, 1.3, 1.4, or 1.5 M) hydrochloric acid solution. Time of stirring may be 10 to 48 hours; for example, 10 to 40 hours; for example, 10 to 30 hours; for example, 10 to 20 hours.

Step S60: The crude product is washed for a second time with water, and remaining ZnCl₂ is removed using tetrahydrofuran (THF).

Step S70: The crude product is dried after second washing to obtain the compound of Q-CTF-OH having a covalent triazine framework. Specifically, in the step, time of drying may be 10 to 48 hours (e.g., 10, 12, 14, 16, 18, 20, 22, 23, 24, 25, 26, 28, 30, 32, 34, 36, 38, 40, 42, 44, 46, or 48 hours), and a temperature of drying may be 50 to 180° C. (e.g., 50, 60, 70, 80, 90, 100, 120, 140, 160, or 180° C.).

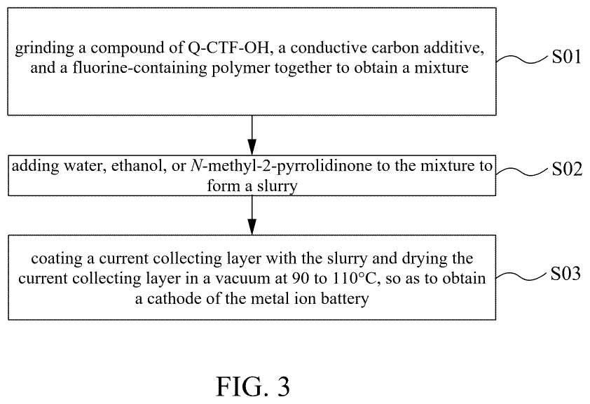

Refer to FIG. 3. A method of preparing cathode of metal ion battery according to another embodiment of the present disclosure comprises the following steps.

Step S01: The compound of Q-CTF-OH prepared by the method as described above, a conductive carbon additive, and a fluorine-containing polymer are ground together to obtain a mixture, wherein a weight ratio of the compound of Q-CTF-OH, the conductive carbon additive, and the fluorine-containing polymer ranges from 3:6:1 to 8:1:1. The fluorine-containing polymer comprises polyvinylidene fluoride or polytetrafluoroethylene. The conductive carbon additive may be conductive carbon black, such as super-conductive carbon black in Ketjen black family. Optionally, Ketjen black may be Ketjen black EC-300J, Ketjen black EC-600JD, Ketjen black ECP-600JD, VXC72, Black Pearls 2000, PRINTEX XE2-B, PRINTEX L6, or HIBLACK 40B2. Optionally, the conductive carbon additive may be Super-P, KS-4, Super C65, or Acetylene Black.

Step S02: Water, ethanol, or N-methyl-2-pyrrolidinone is added to the mixture to form a slurry.

Step S03: A current collecting layer (e.g., a conductive carbon substrate) is coated with the slurry and the current collecting layer is dried in a vacuum at 90 to 110° C. (e.g., 90, 95, 100, 105, or 110° C.) for 8 to 48 hours (e.g., 8, 10, 20, 30, 40, 42, 44, 46, or 48 hours) to obtain the cathode of the metal ion battery.

A metal ion battery according to another embodiment of the present disclosure comprises a cathode, a separator, an anode, and an electrolyte. The cathode is the cathode as described above, the anode is separated from the cathode by the separator, the anode is a metal or alloy thereof, and the electrolyte is disposed between the cathode and the anode. The electrolyte is ethylene carbonate/diethyl carbonate (EC/DEC) electrolyte solution containing lithium hexafluorophosphate. Specifically, a volume ratio of ethylene carbonate to diethyl carbonate may be 1:1, a concentration of the lithium hexafluorophosphate in the electrolyte of the ethylene carbonate/diethyl carbonate electrolyte solution may range from 0.5 to 2 M (e.g., 0.6, 0.7, 0.8, 0.9, 1, 1.1, 1.2, 1.4, 1.6, 1.8, or 2 M), and the metal may be selected from the group consisting of lithium, sodium, potassium, magnesium, and zinc.

Unless otherwise specified herein, the singular forms “a” and “the” used in the specification and the appended claims shall be understood to include the plural. Unless otherwise specified herein, the term “or” used in the specification and the appended claims shall be understood to include “and/or.”

### Synthesis of Q-CTF-OH of the Present Disclosure

### Example 1

A Pyrex glass tube was charged with 19 mg (0.1 mmol) of 1,4-dicyano-2,3,5,6-tetrahydroxybenzene (LH₄) monomer and 68 mg (0.5 mmol) of ZnCl₂ in a glovebox. The Pyrex glass tube was then evacuated, sealed, and heated to the reaction temperature 400° C. for 24 hours with a heating rate of 3° C./min from room temperature. After cooling down to room temperature, the Pyrex glass tube was opened, and the resulting black solid was thoroughly ground in a mortar. The crude product was washed with water under sonication, and then stirred in 1 M HCl solution for 24 hours, followed by washing with water and tetrahydrofuran (THF) to remove the remaining ZnCl₂. The pure Q-CTF-OH (8 mg, yield 43%) was obtained after drying in a vacuum oven at 120° C. for 24 hours.

### Example 2

A Pyrex glass tube was charged with 19 mg (0.1 mmol) of 1,4-dicyano-2,3,5,6-tetrahydroxybenzene (LH₄) monomer and 68 mg (0.5 mmol) of ZnCl₂ in a glovebox. The Pyrex glass tube was then evacuated, sealed, and heated to the reaction temperature 300° C. for 24 hours with a heating rate of 3° C./min from room temperature. After cooling down to room temperature, the Pyrex glass tube was opened, and the resulting black solid was thoroughly ground in a mortar. The crude product was washed with water under sonication, and then stirred in 1 M HCl solution for 24 hours, followed by washing with water and tetrahydrofuran (THF) to remove the remaining ZnCl₂. The pure Q-CTF-OH (7 mg, yield: 38%) was obtained after drying in a vacuum oven at 120° C. for 24 hours.

### Example 3

A Pyrex glass tube was charged with 19 mg (0.1 mmol) of 1,4-dicyano-2,3,5,6-tetrahydroxybenzene (LH₄) monomer and 68 mg (0.5 mmol) of ZnCl₂ in a glovebox. The Pyrex glass tube was then evacuated, sealed, and heated to the reaction temperature 500° C.) for 24 hours with a heating rate of 3° C./min from room temperature. After cooling down to room temperature, the Pyrex glass tube was opened, and the resulting black solid was thoroughly ground in a mortar. The crude product was washed with water under sonication, and then stirred in 1 M HCl solution for 24 hours, followed by washing with water and tetrahydrofuran (THF) to remove the remaining ZnCl₂. The pure Q-CTF-OH (10 mg, yield: 54%) was obtained after drying in a vacuum oven at 120° C. for 24 hours.

### Li-Ion Battery Preparation

### Example 4

An anode material is lithium metal, and an electrolyte is 1 M LiPF₆ in 1:1 v/v mixture of ethylene carbonate/diethyl carbonate (EC/DEC). A Celgard separator is used. A cathode comprises a cathode material mixture, comprising 60 wt % Q-CTF-OH as the active material (Example 1), 30 wt % conductive carbon black (Ketjen black), and 10 wt % poly(vinylidenedifluoride (PVDF), based on 100 wt % of a total weight of the cathode material mixture. Q-CTF-OH, Ketjen black conductive carbon, and PVDF were ground together to obtain the cathode material mixture. N-methyl-2-pyrrolidinone (NMP) was then added to form a slurry, which was coated onto a carbon paper (MGL280) current collector (i.e., the current collector layer). The coated current collector was dried overnight at 100° C. in vacuum to obtain the cathode.

### Example 5

An anode material is lithium metal, and an electrolyte is 1 M LiPF₆ in 1:1 v/v mixture of ethylene carbonate/diethyl carbonate (EC/DEC). A Celgard separator is used. A cathode comprises a cathode material mixture, comprising 30 wt % Q-CTF-OH as the active material (Example 1), 60 wt % conductive carbon black (Ketjen black), and 10 wt % polyvinylidenedifluoride (PVDF), based on 100 wt % of a total weight of the cathode material mixture. Q-CTF-OH, Ketjen black conductive carbon, and PVDF were ground together to obtain the cathode material mixture. N-methyl-2-pyrrolidinone (NMP) was then added to form a slurry, which was coated onto a carbon paper (MGL280) current collector (i.e., the current collector layer). The coated current collector was dried overnight at 100° C. in vacuum to obtain the cathode.

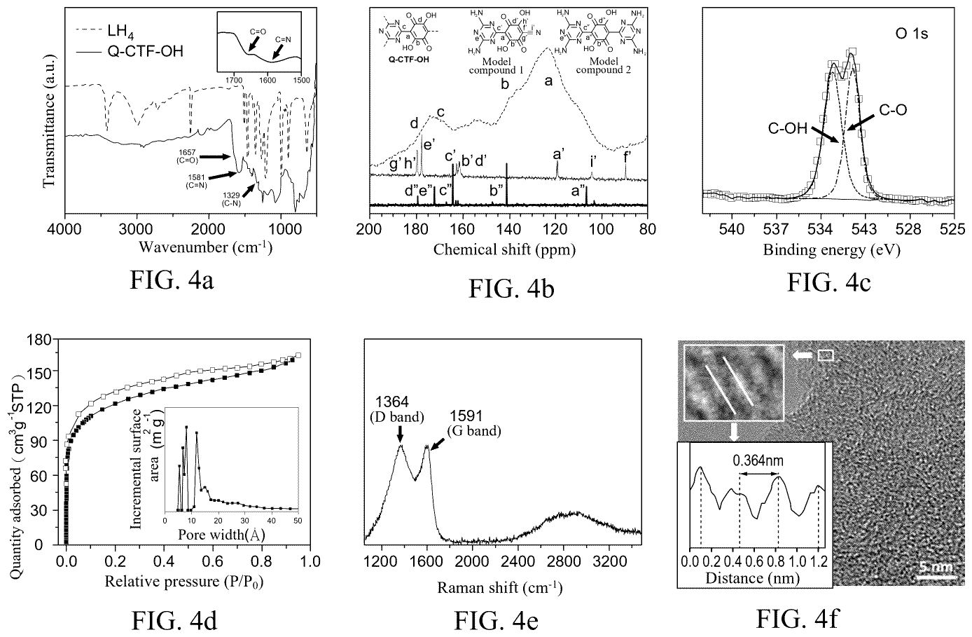

Refer to FIG. 4a. Fourier-transform infrared (FT-IR) spectroscopy was employed to analyze LH₄ and Q-CTF-OH from Example 1, confirming successful formation of triazine ring. As illustrated in FIG. 4a, the FT-IR spectroscopy of Q-CTF-OH, throughout the range of temperatures investigated, does not exhibit a characteristic absorption peak at 2245 cm⁻¹, which is typically attributed to the nitrile (—C≡N) stretching vibration of the LH₄ monomer. Conversely, two additional peaks were observed at 1581 cm⁻¹ and 1329 cm⁻¹, corresponding to C═N and C—N of the triazine ring, respectively, indicating that the nitrile group underwent cyclization. Additionally, a broad absorption peak of C═O centered at 1657 cm⁻¹ was detected, overlapping with C═N signal (refer to an enlarged view in FIG. 4a).

Refer to FIG. 4b. Structure of Q-CTF-OH was investigated using solid-state ¹³C nuclear magnetic resonance (NMR). A resonance peak of C═N of Q-CTF-OH at 172.5 ppm confirmed successful formation of the triazine center through trimerization of the nitrile group, which is consistent with the results of FT-IR.

Refer to FIG. 4c. O 1s XPS data further provide detailed information about the quinone center. Two different components were observed at 531.9 and 533.2 eV in a 1:1 ratio, corresponding to C═O and —OH, respectively.

Refer to FIG. 4d. Nitrogen adsorption/desorption experiments were performed at 77 K to determine porosity of Q-CTF-OH. As illustrated in FIG. 4d, Brunauer-Emmett-Teller (BET) surface area of Q-CTF-OH was 438 m² g⁻¹, and a main pore size was approximately 8 to 12 Å (as shown in an inset in FIG. 4d).

Refer to FIG. 4e. Raman spectrum of Q-CTF-OH shows two prominent peaks at 1346 and 1591 cm⁻¹, corresponding to a D band attributed to an edge and defects of 2D structure and a G band indicating presence of conjugated carbon materials, respectively. In addition, a broad peak at 2865 cm⁻¹ reflects a graphite-like layered configuration. Refer to FIG. 4f. Microstructure of Q-CTF-OH was investigated using high-resolution transmission electron microscopy (HR-TEM). The results reveal that Q-CTF-OH possesses uniformly distributed pores along with visible two-dimensional stacking structures, which are consistent with the Raman result. As shown in an inset of FIG. 4f, a measured interlayer spacing is 0.364 nm, confirming presence of typical TT-IT stacking.

### Electrochemical Analysis

Electrochemical performance of Q-CTF-OH in lithium-ion batteries was investigated using an electrolyte composed of 1 M LiPF₆ dissolved in a 1:1 (v/v) mixture of ethylene carbonate/diethyl carbonate (EC/DEC), and galvanostatic charge/discharge cycling was carried out with a Neware battery cycler. The cyclic voltammetry (CV) and electrochemical impedance spectroscopy (EIS) measurements were performed on a VMP3 system (BioLogic) in a voltage range of 1.1-4.4 V vs. Li/Lit. EIS measurements were carried out over a frequency range of 10 kHz-10 mHz. The coin cells were allowed to rest for at least 30 min before measurements.

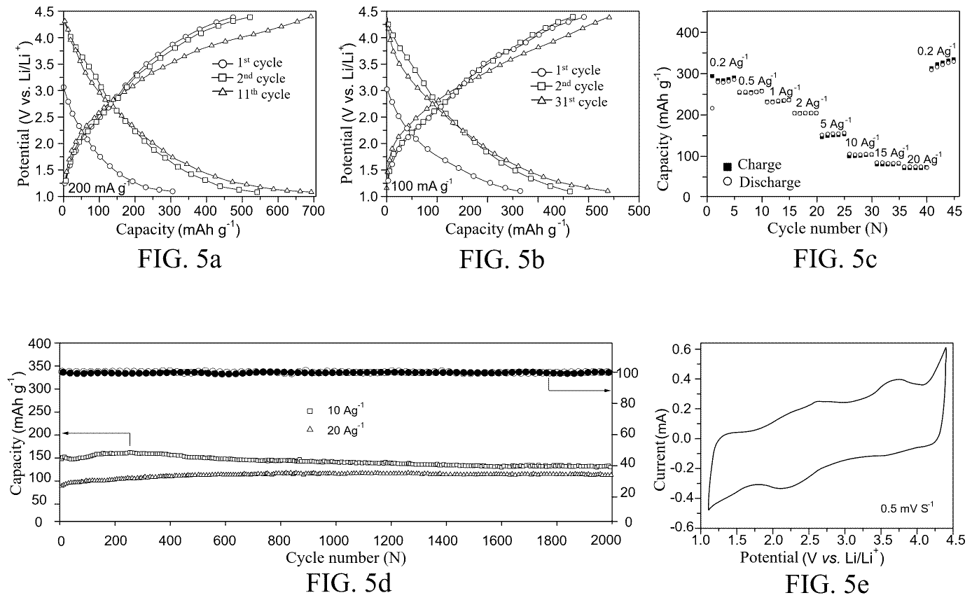

Refer to FIG. 5a. The results show that as the cycle continues, discharge capacity continues to increase. At the 11th cycle, the lithium-ion battery of Example 5 (Example 1: Q-CTF-OH:Ketjenblack:PVDF=3:6:1) reaches a maximum capacity of 689 mAh g⁻¹ at a current density of 200 mA g⁻¹. After deducting capacity contribution of the conductive carbon, the capacity is equivalent to π electrons transferred per repeating unit of Q-CTF-OH, which is highly consistent with an expected theoretical capacity (3 Li⁺ stored on the triazine ring, 3 Lit stored on the carbonyl group, and PF₆⁻ stored on the triazine). The high capacity is essentially derived from the structure of Q-CTF-OH, which has the highest density of redox active sites among all covalent triazine frameworks.

Refer to FIG. 5b. Electrochemical performance of Q-CTF-OH in lithium-ion batteries was further evaluated using Example 4 (i.e., Example 1 with a cathode composition weight ratio of Q-CTF-OH:Ketjenblack:PVDF=6:3:1). At a current density of 100 mA g⁻¹, Q-CTF-OH delivered a maximum discharge capacity of 441 mAh g⁻¹ at the 31^{st} cycle. The decline in capacity is primarily attributed to the lower content of conductive additive, a common limitation observed in organic electrode systems.

A rate capability of the lithium-ion battery in Example 4 was assessed by cycling at a current density from 0.2 to 20 A g⁻¹ and back to 0.2 A g⁻¹. As shown in FIG. 5c, a highly reversible rate performance was observed. The discharge capacities at current densities of 0.2, 0.5, 1, 2, 5, 10, 15, and 20 A g⁻¹ were 278, 254, 232, 204, 151, 105, 84, and 73 mAh g⁻¹, respectively. Upon switching back to 0.2 A g⁻¹, the capacity recovered to 331 mAh g⁻¹.

To further evaluate long-term cycling stability, the lithium-ion battery of Example 4 underwent 2000 charge/discharge cycles. As shown in FIG. 5d, at ultrahigh current densities of 10 and 20 A g⁻¹, the lithium-ion battery delivered reversible capacities of 134 and 118 mAh g⁻¹, respectively. After 2000 cycles, the capacity retention rates remained at 92% and 97%, respectively.

The above results demonstrate that the compound of Q-CTF-OH of the present disclosure exhibits excellent electrochemical performance in lithium-ion batteries, particularly outstanding cycling stability at high current rates. Further, based on a discharge capacity of 441 mAh g⁻¹ at 100 mA g⁻¹ and an average discharge potential of 2.02 V, an estimated gravimetric energy density of Q-CTF-OH is approximately 891 Wh kg⁻¹.

The compound of Q-CTF-OH of the present disclosure was analyzed by cyclic voltammetry (CV) at a scan rate of 0.5 mV s⁻¹. As shown in FIG. 5e, two broad anodic peaks centered at 2.59 V and 3.74 V, along with two broad cathodic peaks centered at 2.20 V and 3.60 V, were observed. These results indicate the presence of multiple redox-active sites within Q-CTF-OH, consistent with the aforementioned characterization data. It is noteworthy that such broad CV features are typical for CTF-based materials.

In summary, the compound of Q-CTF-OH of the present disclosure, when applied in the lithium-ion batteries, provides a high specific capacity of up to 689 mAh g⁻¹ at a current density of 200 mA g⁻¹, and provides a reversible capacity of 118 mAh g⁻¹ at a current density of 20 A g⁻¹. Furthermore, after 2000 charge-discharge cycles, the lithium-ion batteries with the compound of Q-CTF-OH of the present disclosure preserve 97% of the initial capacity.

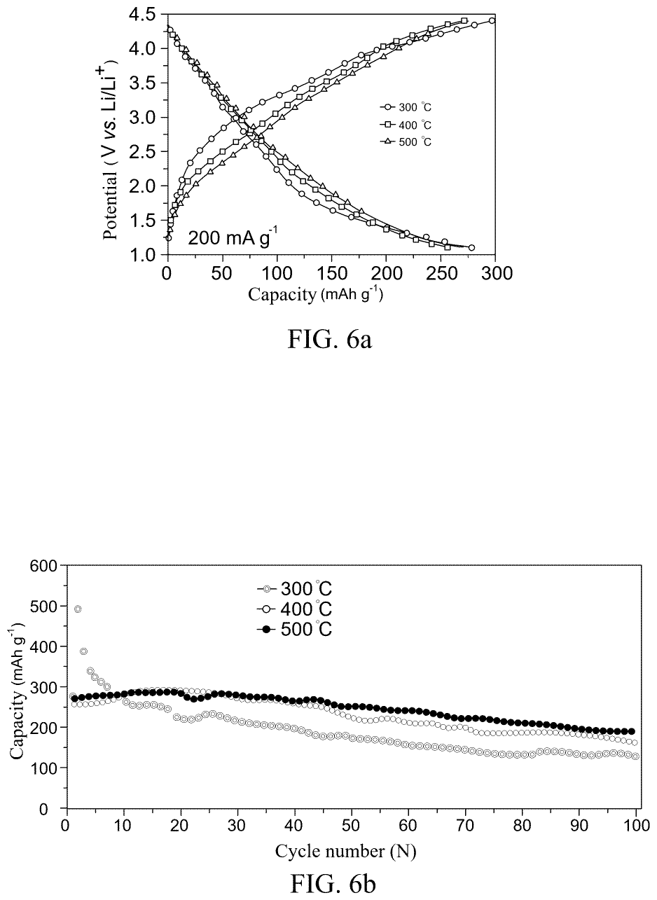

FIG. 6a and FIG. 6b illustrate electrochemical performance of lithium-ion batteries (Q-CTF-OH:Ketjenblack:PVDF=6:3:1) incorporating the compound of Q-CTF-OH of the present disclosure, synthesized at reaction temperatures of 300° C., 400° C., and 500° C., respectively. FIG. 6a shows voltage profiles, while FIG. 6b shows capacity retention at a current density of 200 mA g⁻¹. The results demonstrate that the compounds of Q-CTF-OH synthesized at 400° C. and 500° C. exhibit comparable charge-discharge performance.

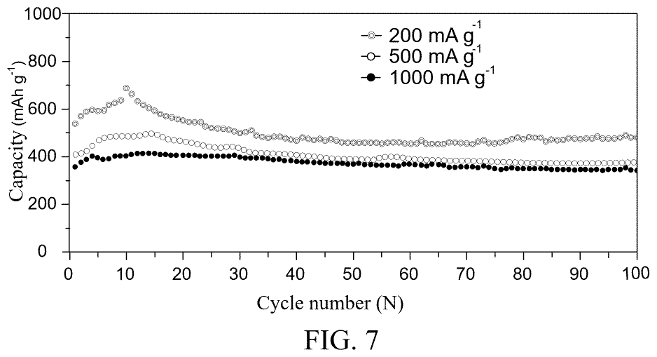

FIG. 7 illustrates capacity retention of lithium-ion batteries from Example 5 (Q-CTF-OH:Ketjenblack:PVDF=3:6:1) at current densities of 200, 500, and 1000 mA g⁻¹. The results demonstrate that the lithium-ion batteries exhibit excellent reversible capacities of 483, 392, and 372 mAh g⁻¹ after 100 cycles at current densities of 200, 500, and 1000 mA g⁻¹, respectively.

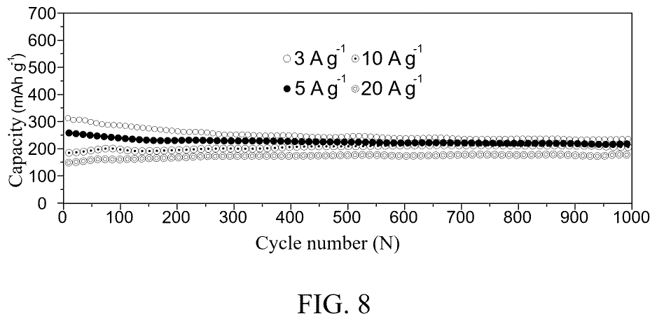

FIG. 8 illustrates capacity retention of lithium-ion batteries from Example 5 (Q-CTF-OH:Ketjenblack:PVDF=3:6:1) at current densities of 3, 5, 10, and 20 A g⁻¹. The results demonstrate that the lithium-ion batteries exhibit reversible capacities of 242, 224, 217, and 180 mAh g⁻¹ after 1000 cycles at current densities of 3, 5, 10, and 20 A g⁻¹, respectively, corresponding to capacity retentions of 74%, 85%, 100%, and 99%.

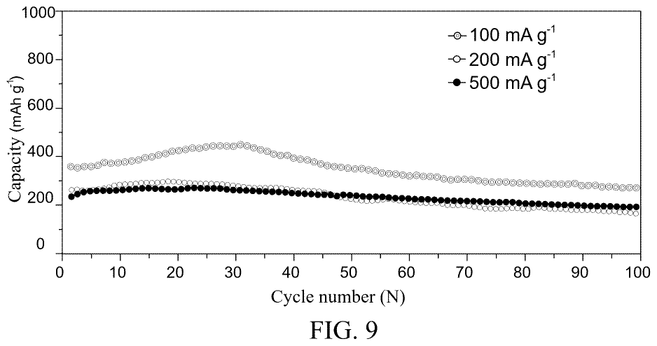

FIG. 9 illustrates capacity retention of lithium-ion batteries from Example 4 (Q-CTF-OH:Ketjenblack:PVDF=6:3:1) at current densities of 100, 200, and 500 mA g⁻¹. The results demonstrate that the electrode material with a higher proportion of Q-CTF-OH exhibits stable charge-discharge performance.

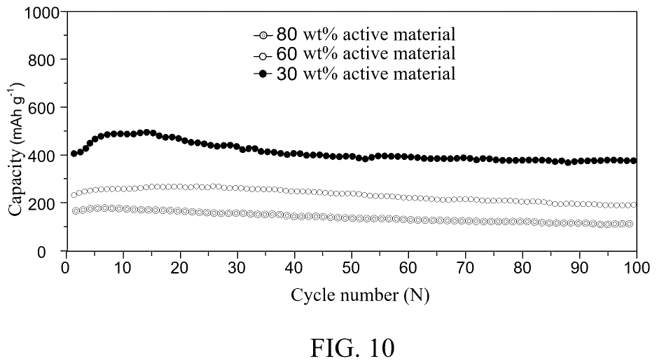

FIG. 10 illustrates capacity retention of lithium-ion batteries with varying contents (80 wt %, 60 wt %, and 30 wt %) of the active material (Q-CTF-OH) at a current density of 500 mA g⁻¹ while keeping PVDF content constant at 10 wt %.

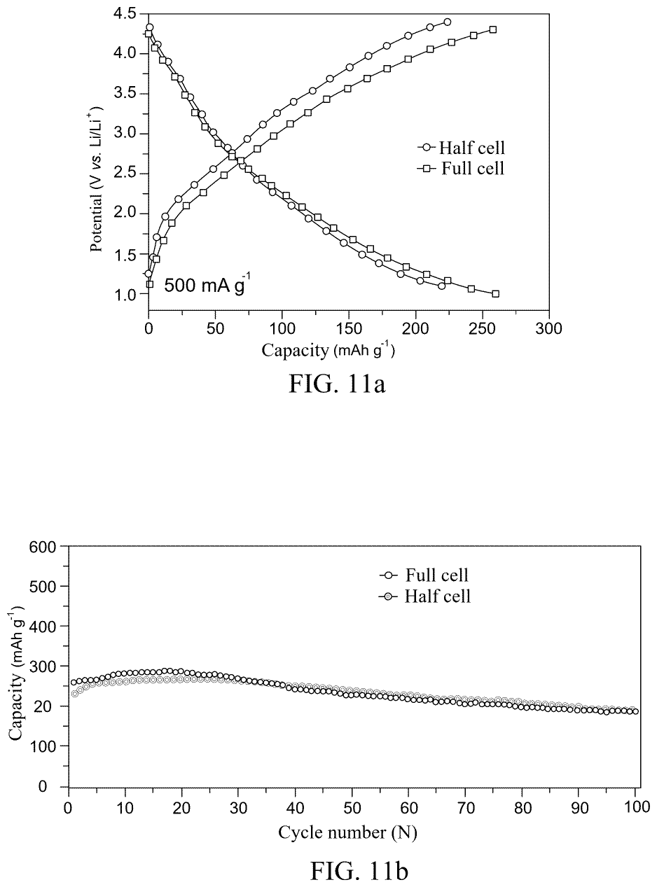

FIG. 11a and FIG. 11b illustrate electrochemical properties of full cell (graphite/Q-CTF-OH) compared with half cell (Li/Q-CTF-OH) at 500 mA g⁻¹ in a voltage range of 1.0-4.3 V. For the full cell, the graphite anode (graphite:Ketjen black:PVDF=8:1:1) was prelithiated at a current density of 100 mA g⁻¹ in a voltage range of 0-3.0 V. The Q-CTF-OH cathode was prepared using the weight ratio of active material:Ketjen black:PVDF=6:3:1. The results indicate that the charge-discharge performance of both the half-cell and full cell is comparable.

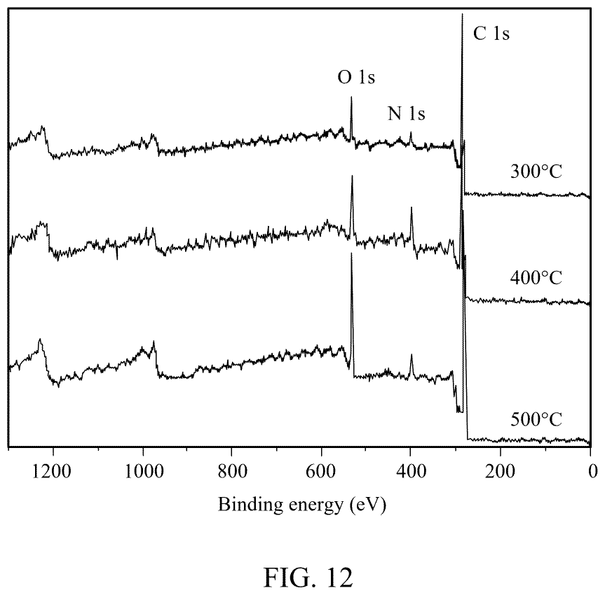

FIG. 12 shows results of Q-CTF-OH synthesized at 300° C., 400° C., and 500° C. analyzed by X-ray photoelectron spectroscopy (XPS). The results show that the Q-CTF-OH obtained by a reaction at 400° C. has more complete triazine structures.

While the preferred embodiments of the present disclosure have been described above, it will be recognized and understood that various changes and modifications can be made, and the appended claims are intended to cover all such changes and modifications which may fall within the spirit and scope of the present disclosure.

What is claimed is:

1. A method of preparing a compound of Q-CTF-OH having a covalent triazine framework as represented in formula (I), 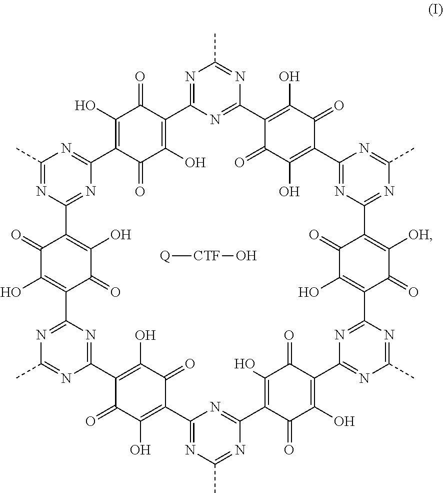
wherein the method comprises steps of:
S10: reacting 1,4-dicyano-2,3,5,6-tetrahydroxybenzene monomer with ZnCl₂ in a vacuum to obtain a solid, wherein a molar ratio of the 1,4-dicyano-2,3,5,6-tetrahydroxybenzene monomer to the ZnCl₂ ranges from 1:0.5 to 1:10, the 1,4-dicyano-2,3,5,6-tetrahydroxybenzene monomer and the ZnCl₂ are heated from room temperature to a temperature in a range of 300 to 500° C., and the temperature is maintained for 10 to 48 hours, so as to obtain the solid.

2. The method of claim 1, further comprising steps of:
S20: cooling the solid to room temperature;
S30: grinding the solid to obtain a crude product;
S40: washing the crude product with water for a first time;
S50: stirring the crude product in an acid solution after first washing;
S60: washing the crude product with water and tetrahydrofuran for a second time; and
S70: drying the crude product after second washing to obtain the compound of Q-CTF-OH.

3. The method of claim 1, wherein in step S10, a heating rate ranges from 1 to 5° C./min.

4. The method of claim 2, wherein in step S40, the crude product is washed with water for the first time under sonication.

5. The method of claim 2, wherein in step S50, time of stirring ranges from 10 to 48 hours.

6. The method of claim 2, wherein in step S70, a temperature of drying ranges from 50 to 180° C.

7. The method of claim 2, wherein in step S70, time of drying ranges from 10 to 48 hours.

8. A compound of Q-CTF-OH as represented in formula (I) prepared by the method of claim 1, 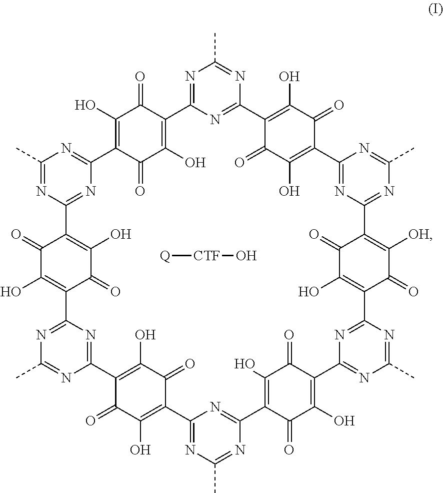
wherein the compound comprises a covalent triazine framework.

9. A method of preparing a cathode of metal ion battery, comprising steps of:
S01: grinding the compound of Q-CTF-OH prepared by the method of claim 1, a conductive carbon additive, and a fluorine-containing polymer together to obtain a mixture, wherein a weight ratio of the compound of Q-CTF-OH, the conductive carbon additive, the fluorine-containing polymer ranges from 3:6:1 to 8:1:1, and the fluorine-containing polymer comprises polyvinylidene fluoride or polytetrafluoroethylene;
S02: adding water, ethanol, or N-methyl-2-pyrrolidinone to the mixture to form a slurry; and
S03: coating a current collecting layer with the slurry and drying the current collecting layer in a vacuum at 90 to 110° C., so as to obtain the cathode of the metal ion battery.

10. The method of claim 9, wherein the current collector layer is a conductive carbon substrate.

11. A metal ion battery, comprising: a cathode, a separator, an anode, and an electrolyte, wherein the cathode is the cathode prepared by the method of claim 9, the anode is separated from the cathode by the separator, the anode is a metal or alloy thereof, and the electrolyte is disposed between the cathode and the anode, wherein the electrolyte is ethylene carbonate/diethyl carbonate electrolyte solution containing lithium hexafluorophosphate.

12. The metal ion battery of claim 11, wherein a concentration of the lithium hexafluorophosphate in the electrolyte of the ethylene carbonate/diethyl carbonate electrolyte solution ranges from 0.5 to 2 M.

13. The metal ion battery of claim 11, wherein the metal is selected from the group consisting of lithium, sodium, potassium, magnesium, and zinc.
